(19) United States
(12) Patent Application Publication
(10) Pub. No.: US 2025/0378359 A1
(43) Pub. Date: Dec. 11, 2025

(54) MAPPING A QUANTUM CIRCUIT TO A QUANTUM PROCESSOR BY PERFORMING A LIGHT CONE ANALYSIS

(71) Applicant: International Business Machines Corporation, Armonk, NY (US)

(72) Inventors: Paul Nation, Yorktown Heights, NY (US); Matthew Treinish, Hopewell Junction, NY (US); Abdullah Ash Saki, Croton on Hudson, NY (US)

(21) Appl. No.: 18/740,203

(22) Filed: Jun. 11, 2024

(51) Int. Cl. G06N 10/20

(52) U.S. Cl. CPC G06N 10/20

(57) ABSTRACT

A method, system, and computer program product for mapping a quantum circuit to a quantum processor. A light cone analysis is performed on the quantum circuit. A light cone refers to a map of the effects that the circuit operations have on the final observable value. Circuit operations that fall outside or within one or more light cones of non-identity operators in an observable based on the light cone analysis on the quantum circuit are then determined. The greater the number of overlapping or individual light cones that such circuit operations lie within, the greater the impact that such circuit operations have on the final observable value. A circuit mapping of the quantum circuit on the quantum processor is then determined based on the determination of which circuit operations fall outside or within the one or more light cones of non-identity operators in the observable.

### TECHNICAL FIELD

The present disclosure relates generally to quantum circuit mapping, and more particularly to mapping a quantum circuit to a quantum processor by performing a light cone analysis.

### BACKGROUND

Quantum circuit mapping refers to the transformation of the quantum circuit such that it complies with the quantum computer architecture's limited qubit connectivity. Quantum circuit mapping is a bijective mapping from vertical qubits in a circuit to physical qubits on a device that obeys the entangling gate connectivity of the device.

Quantum applications have to be adapted to the hardware constraints imposed by current quantum processors. For example, one constraint is the elementary gate set. Generally, only a limited set of quantum gates that can be realized with relatively high fidelity will be predefined on a quantum device. Each quantum technology may support a specific universal set of single-qubit and two-qubit gates. For instance, some superconducting quantum technologies have CZ as an elementary two-qubit gate.

Another constraint is the qubit connectivity. Quantum technologies, such as superconducting qubits and quantum dots, nominally arrange their qubits in 2D architectures with nearest-neighbor (NN) interactions. This means that only neighboring qubits can interact or in other words, qubits are required to be adjacent for performing a two-qubit gate. In other technologies such as trapped-ion qubits, they are fully connected and allow all-to-all interactions.

A further constraint is classical control. Classical electronics are required for controlling and operating the qubits. Using a dedicated instrument per qubit is not scalable and a very expensive approach. Therefore, shared control is required especially when building scalable quantum processors.

All these constraints may vary between different qubit implementations and even within the same quantum technology. In order to meet them, a mapping procedure (quantum circuit mapping) is required to transform a hardware-agnostic quantum circuit into a hardware-aware version that can be run on a given quantum processor.

Such quantum circuit mapping involves mapping virtual qubits (qubits in the circuit) to hardware qubits (physical qubits in the processor). Furthermore, quantum circuit mapping involves routing qubits to move non-adjacent qubits to neighboring positions when they need to interact. To this purpose, the path that the qubits will follow needs to be determined and movement operations, such as shuttling in trapped ion and Si-spin quantum processors, will be inserted accordingly. It is noted that routing will increase the number of operations as well as the circuit depth (the count of time steps needed to execute all the gates in a quantum circuit).

Furthermore, quantum circuit mapping involves scheduling the operations respecting not only the dependencies between them but also the classical control constraints. In addition, gates will be decomposed to elementary gates and the quantum circuit will be optimized at different stages of the compilation process.

Superconducting systems are currently the leading technology for scalable, high-fidelity quantum processors. However, variability across superconducting processors in terms of important performance metrics, such as gate and measurement errors, and qubit coherence times gives rise to large deviations in circuit execution performance across the chip. At present, quantum circuit mapping techniques that heuristically place a quantum circuit on a set of qubits based on device error rates are frequently used. However, these methods do not take into consideration the observable (operator, where the property of the quantum state can be determined by some sequence of operations), if any, that is being evaluated from the output of the quantum circuit. For the common case of low-weight observables, only a subset of the operations in the quantum circuit affect the resulting observable value, especially for low-depth circuits that are executable today, indicating that quantum circuit mapping based on circuit information alone is not enough to ensure that the transformed quantum circuit is optimally mapped to a target device to maximize fidelity of the circuit output.

### SUMMARY

In one embodiment of the present disclosure, a method for mapping a quantum circuit to a quantum processor comprises performing a light cone analysis on the quantum circuit. The method further comprises determining which circuit operations fall outside or within one or more light cones of non-identity operators in an observable based on the light cone analysis on the quantum circuit. The method additionally comprises determining a circuit mapping of the quantum circuit on the quantum processor based on the determination of which circuit operations fall outside or within the one or more light cones of non-identity operators in the observable.

Furthermore, in one embodiment of the present disclosure, the method additionally comprises displaying the circuit mapping of the quantum circuit on the quantum processor, where the circuit operations are mapped to gates and qubits based on the determination of which circuit operations fall outside or within the one or more light cones of non-identity operators in the observable.

Additionally, in one embodiment of the present disclosure, the light cone analysis performed on the quantum circuit generates a numerical value for each circuit operation which indicates a number of light cones that intersect the circuit operation.

Furthermore, in one embodiment of the present disclosure, a higher value of the numerical value associated with the circuit operation indicates a greater impact on a final observable value.

Additionally, in one embodiment of the present disclosure, the circuit operations are prioritized for being mapped to gates and qubits based on the numerical value.

Furthermore, in one embodiment of the present disclosure, circuit operations that are associated with a numerical value of zero correspond to circuit operations that fall outside of the one or more light cones.

Additionally, in one embodiment of the present disclosure, the method further comprises removing the circuit operations that are associated with the numerical value of zero from the quantum circuit.

Other forms of the embodiments of the method described above are in a system and in a computer program product.

Accordingly, embodiments of the present disclosure improve the quantum circuit mapping process by selectively mapping operations within a circuit to qubits within a device topology that heuristically minimizes the errors associated with only those operations that fall within one or more light cones of a given observable.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 is a diagram of the software components of the classical computer for mapping a quantum circuit to a quantum processor that takes into account the observables that are evaluated from the quantum circuit output thereby ensuring that the transformed quantum circuit complies with the quantum computer architecture's limited qubit connectivity and optimized for output fidelity in accordance with an embodiment of the present disclosure;

FIG. 3 illustrates a map of the number of light cones that intersect a given circuit operation in accordance with an embodiment of the present disclosure;

FIG. 4 illustrates an alternative map of the number of light cones that intersect a given circuit operation in accordance with an embodiment of the present disclosure;

FIG. 5 illustrates an embodiment of the present disclosure of the hardware configuration of the classical computer which is representative of a hardware environment for practicing the present disclosure; and

FIG. 6 is a flowchart of a method for mapping a quantum circuit to a quantum processor by performing a light cone analysis in accordance with an embodiment of the present disclosure.

### DETAILED DESCRIPTION

In one embodiment of the present disclosure, a method for mapping a quantum circuit to a quantum processor comprises performing a light cone analysis on the quantum circuit. The method further comprises determining which circuit operations fall outside or within one or more light cones of non-identity operators in an observable based on the light cone analysis on the quantum circuit. The method additionally comprises determining a circuit mapping of the quantum circuit on the quantum processor based on the determination of which circuit operations fall outside or within the one or more light cones of non-identity operators in the observable.

In this manner, the quantum circuit mapping process is improved by ensuring that the transformed quantum circuit is optimally mapped to a target device to maximize fidelity of the circuit output.

Furthermore, in one embodiment of the present disclosure, the method additionally comprises displaying the circuit mapping of the quantum circuit on the quantum processor, where the circuit operations are mapped to gates and qubits based on the determination of which circuit operations fall outside or within the one or more light cones of non-identity operators in the observable.

In this manner, circuit operations that have a greater impact on the final observable value are prioritized to be mapped to the gates and qubits over those circuit operations with a lower impact on the final observable value.

Additionally, in one embodiment of the present disclosure, the light cone analysis performed on the quantum circuit generates a numerical value for each circuit operation which indicates a number of light cones that intersect the circuit operation.

In this manner, circuit operations that fall outside or within one or more light cones can be determined thereby determining which circuit operations have a greater impact on the final observable value in comparison to other circuit operations.

Furthermore, in one embodiment of the present disclosure, a higher value of the numerical value associated with the circuit operation indicates a greater impact on a final observable value.

In this manner, circuit operations can be prioritized as to which circuit operations are to be mapped to the gates and qubits thereby ensuring that the transformed quantum circuit complies with the quantum computer architecture's limited qubit connectivity and optimized for output fidelity.

Additionally, in one embodiment of the present disclosure, the circuit operations are prioritized for being mapped to gates and qubits based on the numerical value.

In this manner, circuit operations can be prioritized as to which circuit operations are to be mapped to the gates and qubits thereby ensuring that the transformed quantum circuit is optimally mapped to a target device to maximize fidelity of the circuit output.

Furthermore, in one embodiment of the present disclosure, circuit operations that are associated with a numerical value of zero correspond to circuit operations that fall outside of the one or more light cones.

In this manner, circuit operations that have no role in the final observable value can be identified and ignored in the quantum circuit mapping process.

Additionally, in one embodiment of the present disclosure, the method further comprises removing the circuit operations that are associated with the numerical value of zero from the quantum circuit.

In this manner, circuit operations that have no role in the final observable value can be removed thereby reducing the possibility of errors, such as cross-talk.

Other forms of the embodiments of the method described above are in a system and in a computer program product.

As stated above, quantum applications have to be adapted to the hardware constraints imposed by current quantum processors. For example, one constraint is the elementary gate set. Generally, only a limited set of quantum gates that can be realized with relatively high fidelity will be predefined on a quantum device. Each quantum technology may support a specific universal set of single-qubit and two-qubit gates. For instance, some superconducting quantum technologies have CZ as an elementary two-qubit gate.

Another constraint is the qubit connectivity. Quantum technologies, such as superconducting qubits and quantum dots, nominally arrange their qubits in 2D architectures with nearest-neighbor (NN) interactions. This means that only neighboring qubits can interact or in other words, qubits are required to be adjacent for performing a two-qubit gate. In other technologies such as trapped-ion qubits, they are fully connected and allow all-to-all interactions.

A further constraint is classical control. Classical electronics are required for controlling and operating the qubits. Using a dedicated instrument per qubit is not scalable and a very expensive approach. Therefore, shared control is required especially when building scalable quantum processors.

All these constraints may vary between different qubit implementations and even within the same quantum technology. In order to meet them, a mapping procedure (quantum circuit mapping) is required to transform a hardware-agnostic quantum circuit into a hardware-aware version that can be run on a given quantum processor.

Such quantum circuit mapping involves mapping virtual qubits (qubits in the circuit) to hardware qubits (physical qubits in the processor). Furthermore, quantum circuit mapping involves routing qubits to move non-adjacent qubits to neighboring positions when they need to interact. To this purpose, the path that the qubits will follow needs to be determined and movement operations, such as shuttling in trapped ion and Si-spin quantum processors, will be inserted accordingly. It is noted that routing will increase the number of operations as well as the circuit depth (the count of time steps needed to execute all the gates in a quantum circuit).

Furthermore, quantum circuit mapping involves scheduling the operations respecting not only the dependencies between them but also the classical control constraints. In addition, gates will be decomposed to elementary gates and the quantum circuit will be optimized at different stages of the compilation process.

Superconducting systems are currently the leading technology for scalable, high-fidelity quantum processors. However, variability across superconducting processors in terms of important performance metrics, such as gate and measurement errors, and qubit coherence times gives rise to large deviations in circuit execution performance across the chip. At present, quantum circuit mapping techniques that heuristically place a quantum circuit on a set of qubits based on device error rates are frequently used. However, these methods do not take into consideration the observable (operator, where the property of the quantum state can be determined by some sequence of operations), if any, that is being evaluated from the output of the quantum circuit. For the common case of low-weight observables, only a subset of the operations in the quantum circuit affect the resulting observable value, especially for low-depth circuits that are executable today, indicating that quantum circuit mapping based on circuit information alone is not enough to ensure that the transformed quantum circuit is optimally mapped to a target device to maximize fidelity of the circuit output.

The embodiments of the present disclosure provide the means for mapping a quantum circuit to a quantum processor that takes into account the observables (operator, where the property of the quantum state can be determined by some sequence of operations) that are evaluated from the quantum circuit output by performing a light cone analysis thereby ensuring that the transformed quantum circuit is optimally mapped to a target device to maximize fidelity of the circuit output. In one embodiment, a light cone analysis is performed on a quantum circuit to determine an effect that the circuit operations have on the final observable value. A light cone, as used herein, refers to a map of the effects that the circuit operations have on the final observable value. In one embodiment, the light cone is generated by computing time-evolved commutators of circuit operations and an observable (e.g., energy) on a portion of the quantum circuit. A “light cone analysis,” as used herein, refers to the analysis of the quantum circuit generating one or more light cones. Based on the light cone analysis, the circuit operations which fall outside or within one or more light cones of non-identity operators in an observable are determined. The circuit mapping of the quantum circuit on the quantum processor is then determined based on which circuit operations fall outside or within the one or more light cones of the non-identity operators in the observable. For example, circuit operations that fall outside of the light cones have no role in the final observable value and therefore can be ignored in the quantum circuit mapping process. Those circuit operations that are within the light cones are then prioritized based on the number of overlapping or individual light cones that such circuit operations lie within. For instance, those circuit operations with a greater number of overlapping light cones have a greater impact on the final observable value than those circuit operations with a fewer number of overlapping or individual light cones. As a result, those circuit operations with a greater number of overlapping or individual light cones have a higher priority than those circuit operations with a fewer number of overlapping or individual light cones. The circuit operations are then mapped to gates and qubits based on such prioritization. By weighting the circuit operations by the number of light cones they lie within, the quantum circuit mapping process now more accurately ensures that the transformed quantum circuit complies with the quantum computer architecture's limited qubit connectivity and optimized for output fidelity. These and other features will be discussed in further detail below.

In some embodiments of the present disclosure, the present disclosure comprises a method, system, and computer program product for mapping a quantum circuit to a quantum processor. In one embodiment of the present disclosure, a light cone analysis is performed on the quantum circuit. A “light cone,” as used herein, refers to a map of the effects that the circuit operations have on the final observable value. A “light cone analysis,” as used herein, refers to the analysis of the quantum circuit generating one or more light cones. In one embodiment, the light cone is generated by computing time-evolved commutators of circuit operations and an observable (e.g., energy) on a portion of the quantum circuit. Commutators provide an indication of the extent to which a circuit operation impacts the observed outcome with respect to the observable (e.g., energy). An observable, as used herein, refers to the properties of the system that can be measured, such as position, momentum, angular momentum, energy, a binary value of a qubit, etc. As a result, the light cone indicates the impact of the circuit operation on the final observable. Circuit operations that fall outside or within the one or more light cones of non-identity operators in an observable based on the light cone analysis on the quantum circuit are then determined. Those circuit operations that fall outside the light cones of non-identity operators in an observable have no role in the final observable value and therefore can be ignored in the quantum circuit mapping process. Those circuit operations that fall within the light cone(s) of non-identity operators in an observable do have an impact in the final observable value and are utilized in the quantum circuit mapping process. The greater the number of overlapping or individual light cones that such circuit operations lie within, the greater the impact that such circuit operations have on the final observable value. A circuit mapping of the quantum circuit on the quantum processor is then determined based on the determination of which circuit operations fall outside or within the one or more light cones of non-identity operators in the observable. In one embodiment, the circuit operations are mapped to the gates and qubits based, at least in part, on the impact on the final observable value identified from the light cone analysis. Those circuit operations that are within the light cones as identified from the light cone analysis are prioritized based on the number of overlapping or individual light cones that such circuit operations lie within, where the greater number of overlapping or individual light cones, the higher the priority. Based on such prioritization (or weightings), along with gate and qubit errors, circuit operations are mapped to the gates and qubits. As a result, the light cone powered mapping of the present disclosure can map the quantum circuit to better quality physical qubits, which can result in better quality outputs from the execution of the quantum circuit on the quantum computer.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

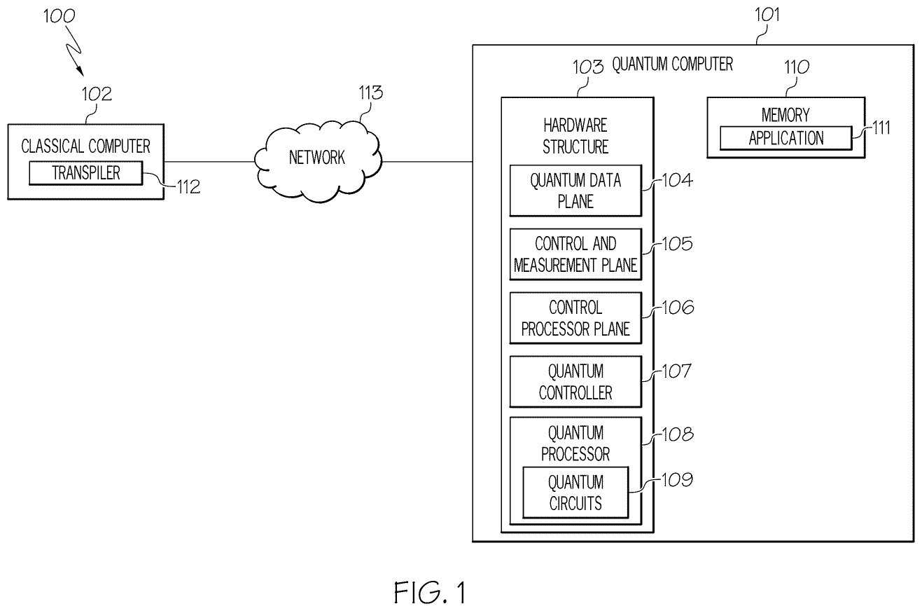

Referring now to the Figures in detail, FIG. 1 illustrates an embodiment of the present disclosure of a communication system 100 for practicing the principles of the present disclosure. Communication system 100 includes a quantum computer 101 configured to perform quantum computations, such as the types of computations that harness the collective properties of quantum states, such as superposition, interference, and entanglement, as well as a classical computer 102 in which information is stored in bits that are represented logically by either a 0 (off) or a 1 (on). Examples of classical computer 102 include, but are not limited to, a portable computing unit, a Personal Digital Assistant (PDA), a laptop computer, a mobile device, a tablet personal computer, a smartphone, a mobile phone, a navigation device, a gaming unit, a desktop computer system, a workstation, and the like configured with the capability of connecting to network 113 (discussed below).

In one embodiment, classical computer 102 is used to set up the state of quantum bits in quantum computer 101 and then quantum computer 101 starts the quantum process. Furthermore, in one embodiment, classical computer 102 is configured to map a quantum circuit to a quantum processor that takes into account the observables (operator, where the property of the quantum state can be determined by some sequence of operations) that are evaluated from the quantum circuit output thereby ensuring that the transformed quantum circuit is optimally mapped to a target device to maximize fidelity of the circuit output.

In one embodiment, a hardware structure 103 of quantum computer 101 includes a quantum data plane 104, a control and measurement plane 105, a control processor plane 106, a quantum controller 107, and a quantum processor 108. While depicted as being located on a single machine, quantum data plane 104, control and measurement plane 105, and control processor plane 106 may be distributed across multiple computing machines, such as in a cloud computing architecture, and communicate with quantum controller 107, which may be located in close proximity to quantum processor 108.

Quantum data plane 104 includes the physical qubits or quantum bits (basic unit of quantum information in which a qubit is a two-state (or two-level) quantum-mechanical system) and the structures needed to hold them in place. In one embodiment, quantum data plane 104 contains any support circuitry needed to measure the qubits' state and perform gate operations on the physical qubits for a gate-based system or control the Hamiltonian for an analog computer. In one embodiment, control signals routed to the selected qubit(s) set a state of the Hamiltonian. For gate-based systems, since some qubit operations require two qubits, quantum data plane 104 provides a programmable “wiring” network that enables two or more qubits to interact.

Control and measurement plane 105 converts the digital signals of quantum controller 107, which indicates what quantum operations are to be performed, to the analog control signals needed to perform the operations on the qubits in quantum data plane 104. In one embodiment, control and measurement plane 105 converts the analog output of the measurements of qubits in quantum data plane 104 to classical binary data that quantum controller 107 can handle.

Control processor plane 106 identifies and triggers the sequence of quantum gate operations and measurements (which are subsequently carried out by control and measurement plane 105 on quantum data plane 104). These sequences execute the program, provided by quantum processor 108, for implementing a quantum algorithm.

In one embodiment, control processor plane 106 runs the quantum error correction algorithm (if quantum computer 101 is error corrected).

In one embodiment, quantum processor 108 uses qubits to perform computational tasks. In the particular realms where quantum mechanics operate, particles of matter can exist in multiple states, such as an “on” state, an “off” state, and both “on” and “off” states simultaneously. Quantum processor 108 harnesses these quantum states of matter to output signals that are usable in data computing.

In one embodiment, quantum processor 108 performs algorithms which conventional processors are incapable of performing efficiently.

In one embodiment, quantum processor 108 includes one or more quantum circuits 109. Quantum circuits 109 may collectively or individually be referred to as quantum circuits 109 or quantum circuit 109, respectively. A “quantum circuit 109,” as used herein, refers to a model for quantum computation in which a computation is a sequence of quantum logic gates, measurements, initializations of qubits to known values and possibly other actions. A “quantum logic gate,” as used herein, is a reversible unitary transformation on at least one qubit. Quantum logic gates, in contrast to classical logic gates, are all reversible. Examples of quantum logic gates include RX (performs e^{iθX/2}, which corresponds to a rotation of the qubit state around the X-axis by the given angle theta θ on the Bloch sphere), RY (performs e^{iθY/2}, which corresponds to a rotation of the qubit state around the Y-axis by the given angle theta θ on the Bloch sphere), RXX (performs the operation e^{(-iθX⊗X/2}^{₎} on the input qubit), RZZ (takes in one input, an angle theta θ expressed in radians, and it acts on two qubits), etc. In one embodiment, quantum circuits 109 are written such that the horizontal axis is time, starting at the left-hand side and ending at the right-hand side.

Furthermore, in one embodiment, quantum circuit 109 corresponds to a command structure provided to control processor plane 106 on how to operate control and measurement plane 105 to run the algorithm on quantum data plane 104/quantum processor 108.

Furthermore, quantum computer 101 includes memory 110, which may correspond to quantum memory. In one embodiment, memory 110 is a set of quantum bits that store quantum states for later retrieval. The state stored in quantum memory 110 can retain quantum superposition.

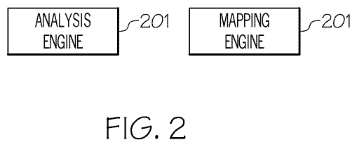

In one embodiment, memory 110 stores an application 111 that may be configured to implement one or more of the methods described herein in accordance with one or more embodiments. For example, application 111 may implement a program for mapping a quantum circuit to a quantum processor that takes into account the observables (operator, where the property of the quantum state can be determined by some sequence of operations) that are evaluated from the quantum circuit output thereby ensuring that the transformed quantum circuit is optimally mapped to a target device to maximize fidelity of the circuit output as discussed further below in connection with FIGS. 2-4 and 6. Examples of memory 110 include light quantum memory, solid quantum memory, gradient echo memory, electromagnetically induced transparency, etc.

Furthermore, in one embodiment, classical computer 102 includes a “transpiler 112,” which as used herein, is configured to rewrite an abstract quantum circuit 109 into a functionally equivalent one that matches the constraints and characteristics of a specific target quantum device. In one embodiment, transpiler 112 (e.g., qiskit.transpiler, where Qiskit® is an open-source software development kit for working with quantum computers at the level of circuits, pulses, and algorithms) rewrites a given input circuit to match the topology of a specific quantum device and/or to optimize the quantum circuit for execution. In one embodiment, transpiler 112 converts a trained machine learning model upon execution on quantum hardware 103 to its elementary instructions and maps it to physical qubits.

In one embodiment, quantum machine learning models are based on variational quantum circuits 109. Such models consist of data encoding, processing parameterized with trainable parameters, and measurement/post-processing.

In one embodiment, the number of qubits (basic unit of quantum information in which a qubit is a two-state (or two-level) quantum-mechanical system) is determined by the number of features in the data. This processing stage may include multiple layers of parameterized gates. As a result, in one embodiment, the number of trainable parameters is (number of features) * (number of layers).

Furthermore, as shown in FIG. 1, classical computer 102, which is used to set up the state of quantum bits in quantum computer 101, may be connected to quantum computer 101 via network 113.

Network 113 may be, for example, a quantum network, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, a cellular network and various combinations thereof, etc. Other networks, whose descriptions are omitted here for brevity, may also be used in conjunction with system 100 of FIG. 1 without departing from the scope of the present disclosure.

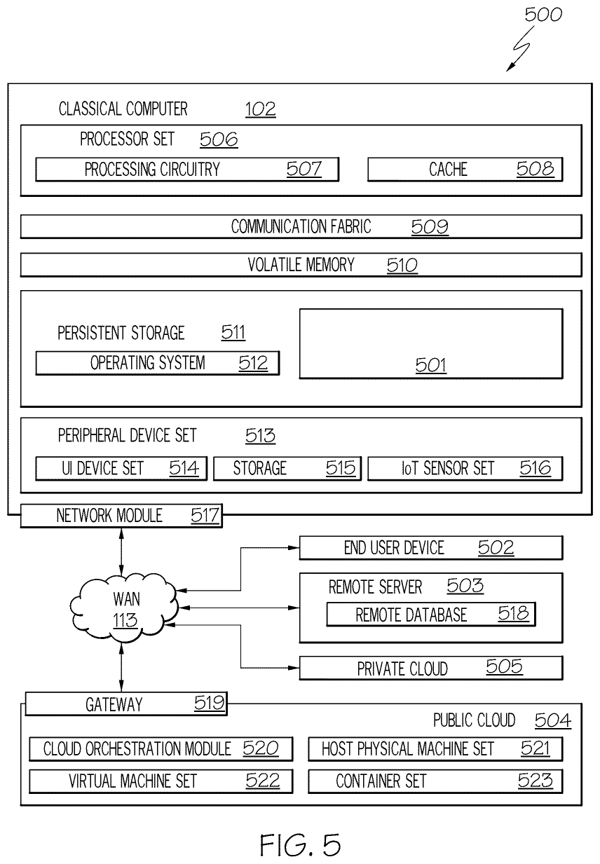

Furthermore, classical computer 102 is configured to map a quantum circuit to a quantum processor that takes into account the observables (operator, where the property of the quantum state can be determined by some sequence of operations) that are evaluated from the quantum circuit output thereby ensuring that the transformed quantum circuit is optimally mapped to a target device to maximize fidelity of the circuit output as discussed further below in connection with FIGS. 2-4 and 6. A description of the software components of classical computer 102 is provided below in connection with FIG. 2 and a description of the hardware configuration of classical computer 102 is provided further below in connection with FIG. 5.

System 100 is not to be limited in scope to any one particular network architecture. System 100 may include any number of quantum computers 101, classical computers 102, and networks 113.

A discussion regarding the software components used by classical computer 102 for mapping a quantum circuit to a quantum processor that takes into account the observables (operator, where the property of the quantum state can be determined by some sequence of operations) that are evaluated from the quantum circuit output is provided below in connection with FIG. 2.

FIG. 2 is a diagram of the software components of classical computer 102 (FIG. 1) for mapping a quantum circuit to a quantum processor that takes into account the observables (operator, where the property of the quantum state can be determined by some sequence of operations) that are evaluated from the quantum circuit output thereby ensuring that the transformed quantum circuit complies with the quantum computer architecture's limited qubit connectivity and optimized for output fidelity in accordance with an embodiment of the present disclosure.

Referring to FIG. 2, in conjunction with FIG. 1, classical computer 102 includes analysis engine 201 configured to perform a light cone analysis on a quantum circuit (e.g., quantum circuit 109). A “light cone,” as used herein, refers to a map of the effects that the circuit operations have on the final observable value. A “light cone analysis,” as used herein, refers to the analysis of the quantum circuit generating one or more light cones. Based on the light cone analysis, the circuit operations which fall within one or more light cones of non-identity operators in an observable are determined as discussed further below.

In one embodiment, analysis engine 201 generates the light cone by computing time-evolved commutators of circuit operations and an observable (e.g., energy) on a portion of the quantum circuit (e.g., quantum circuit 109). Commutators provide an indication of the extent to which a circuit operation impacts the observed outcome with respect to the observable (e.g., energy). An observable, as used herein, refers to the properties of the system that can be measured, such as position, momentum, angular momentum, energy, a binary value of a qubit, etc. As a result, the light cone indicates the impact of the circuit operation on the final observable value.

In one embodiment, analysis engine 201 generates the light cone by the quantum hyperbolae T 2−X 2=±[X, T]=±1. In one embodiment, the light cone corresponds to the surface describing the temporal evolution of a flash of light in Minkowski spacetime.

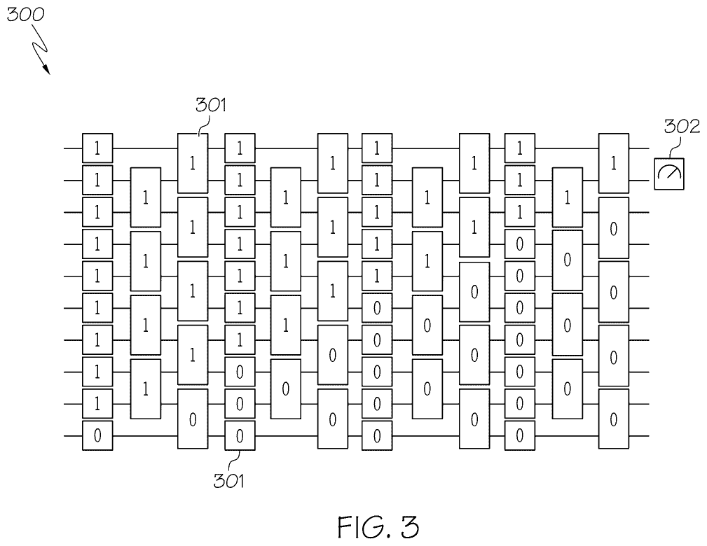

In one embodiment, such a light cone corresponds to a light cone of the non-identity operators in a given observable, where measurements of the number of light cones that intersect a given circuit operation may be displayed in a map as discussed further below in connection with FIG. 3.

In one embodiment, analysis engine 201 determines an impact that a circuit operation has on the final observable value by determining which circuit operations fall outside or within one or more light cones of non-identity operators in an observable based on the light cone analysis on the quantum circuit. Those circuit operations that fall outside the light cones of non-identity operators in an observable have no role in the final observable value and therefore can be ignored in the quantum circuit mapping process. Those circuit operations that fall within the light cone(s) of non-identity operators in an observable do have an impact in the final observable value and are utilized in the quantum circuit mapping process as discussed further below.

In one embodiment, based on the light cone analysis on the quantum circuit, measurements of the number of light cones that intersect a given circuit operation may be displayed in a map as shown in FIG. 3.

FIG. 3 illustrates a map of the number of light cones that intersect a given circuit operation in accordance with an embodiment of the present disclosure.

As shown in FIG. 3, the light cone analysis performed on the quantum circuit generates a map 300 containing a numerical value 301 (e.g., 0, 1) for each circuit operation which indicates a number of light cones that intersect the circuit operation. Such numerical values 301 are computed by measurement operation 302 based on the analysis performed by analysis engine 201 in determining which circuit operations fall outside or within a light cone of non-identity operators in an observable. For example, such numerical values 301 may indicate a value of 0 to indicate that the corresponding circuit operation falls outside the light cones of non-identity operators in an observable; whereas, a value of 1 indicates that the corresponding circuit operation falls within a light cone of non-identity operators in an observable.

In one embodiment, analysis engine 201 identifies those circuit operations that fall outside the light cones of non-identity operators in an observable based on being associated with a numerical value of 0 in map 300. Such circuit operations have no role in the final observable value and therefore can be ignored in the quantum circuit mapping process. In one embodiment, analysis engine 201 optionally removes such circuit operations from the quantum circuit, such as to reduce the possibility of cross-talk.

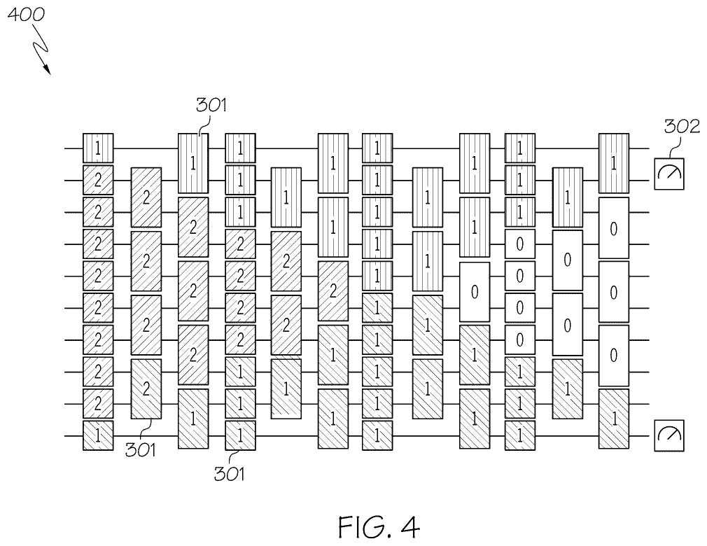

As previously discussed, such circuit operations that fall within a light cone of non-identity operators in an observable are identified based on being associated with a numerical value of 1 in map 300. In one embodiment, analysis engine 201 prioritizes such circuit operations based on the number of overlapping or individual light cones that such circuit operations lie within as discussed below in connection with FIG. 4.

FIG. 4 illustrates an alternative map of the number of light cones that intersect a given circuit operation in accordance with an embodiment of the present disclosure.

As shown in FIG. 4, based on the light cone analysis performed on the quantum circuit, measurements of the number of light cones that intersect a given circuit operation may be displayed in map 400, where map 400 indicates the number of overlapping or individual light cones that such circuit operations lie within via numerical values 301. In one embodiment, such numerical values 301 are computed by measurement operation 302 based on the analysis performed by analysis engine 201 in determining which circuit operations fall outside or within one or more light cones of non-identity operators in an observable.

For example, as shown in FIG. 4, such numerical values 301 may indicate a value of 0 to indicate that the corresponding circuit operation falls outside the light cones of non-identity operators in an observable, a value of 1 to indicate that the corresponding circuit operation falls within a light cone of non-identity operators in an observable, or a value of 2 to indicate that the corresponding circuit operation falls within two light cones of non-identity operators in an observable. The higher the value of numerical value 301, the greater the impact that the corresponding circuit operation has on the final observable value. While map 400 only illustrates the values of 0, 1 and 2 for numerical values 301, the circuit operations may fall within any number of light cones of non-identity operators in an observable, and hence, numerical values 301 may indicate other values than 0, 1 and 2, such as 3, 4, etc.

For observables of weight lager than one (i.e., circuit operations being associated with a numerical value 301 greater than one), the intersection of light cones indicates that operators within the intersection impact multiple terms in the observable, and thus have an outsized impact on the resulting output. As a result, mapping (quantum circuit mapping) such circuit operations to the gates and qubits with lower error rates are prioritized over circuit operations that lie within a smaller number of overlapping or individual light cones.

Classical computer 102 further includes mapping engine 202 configured to determine a circuit mapping of the quantum circuit (e.g., quantum circuit 109) on the quantum processor (e.g., quantum processor 108) based on the determination of which circuit operations fall outside or within the one or more light cones of non-identity operators in the observable.

In one embodiment, mapping engine 202 performs the circuit mapping of the quantum circuit (e.g., quantum circuit 109) on the quantum processor (e.g., quantum processor 108) based on the prioritization (or weighting) of the circuit operations, which is based on the determination of which circuit operations fall outside or within the one or more light cones of non-identity operators in the observable. In one embodiment, mapping engine 202 maps the circuit operations to the gates and qubits based, at least in part, on the impact on the final observable value identified from the light cone analysis. As discussed above, those circuit operations that are within the light cones as identified from the light cone analysis are prioritized based on the number of overlapping or individual light cones that such circuit operations lie within. In one embodiment, based on such prioritization (or weightings), along with gate and qubit errors, circuit operations are mapped to the gates and qubits.

In one embodiment, mapping engine 202 performs the circuit mapping of the quantum circuit (e.g., quantum circuit 109) on the quantum processor (e.g., quantum processor 108) using a heuristic scoring of the quantum circuit in terms of such prioritizations (or weights). In one embodiment, mapping engine 202 performs the circuit mapping of the quantum circuit (e.g., quantum circuit 109) on the quantum processor (e.g., quantum processor 108) using a heuristic scoring of the quantum circuit in terms of such prioritizations (or weights) in combination with the gate and qubit errors.

In one embodiment, mapping engine 202 performs the circuit mapping of the quantum circuit (e.g., quantum circuit 109) on the quantum processor (e.g., quantum processor 108) based, at least in part, on the prioritization (or weighting) of the circuit operations using various software tools, including, but not limited to, Mapomatic, Munich Quantum Toolkit (MQT) QMAP, etc.

In one embodiment, mapping engine 202 is configured to display the circuit mapping of the quantum circuit (e.g., quantum circuit 109) on the quantum processor (e.g., quantum processor 108), where the circuit operations are mapped to the gates and qubits based, at least in part, on the prioritization (or weighting) of the circuit operations identified from the light cone analysis. In one embodiment, such a circuit mapping of the quantum circuit on the quantum processor is displayed on a user interface of a computing device (e.g., classical computer 102). In one embodiment, mapping engine 202 utilizes various software tools for displaying the circuit mapping of the quantum circuit on the quantum processor, including, but not limited to, Berkeley Quantum Synthesis Toolkit, Mapomatic, Munich Quantum Toolkit (MQT) QMAP, etc.

In this manner, by weighting the circuit operations by the number of light cones they lie within, where such light cones map the effects that the circuit operations have on the final observable value, the quantum circuit mapping process now more accurately ensures that the transformed quantum circuit complies with the quantum computer architecture's limited qubit connectivity and optimized for output fidelity.

A further description of these and other functions is provided below in connection with the discussion of the method for mapping a quantum circuit to a quantum processor by performing a light cone analysis.

Prior to the discussion of the method for mapping a quantum circuit to a quantum processor by performing a light cone analysis, a description of the hardware configuration of classical computer 102 (FIG. 1) is provided below in connection with FIG. 5.

Referring now to FIG. 5, in conjunction with FIG. 1, FIG. 5 illustrates an embodiment of the present disclosure of the hardware configuration of classical computer 102 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 500 contains an example of an environment for the execution of at least some of the computer code 501 involved in performing the inventive methods, such as mapping a quantum circuit to a quantum processor by performing a light cone analysis. In addition to block 501, computing environment 500 includes, for example, classical computer 102, network 113, such as a wide area network (WAN), end user device (EUD) 502, remote server 503, public cloud 504, and private cloud 505. In this embodiment, classical computer 102 includes processor set 506 (including processing circuitry 507 and cache 508), communication fabric 509, volatile memory 510, persistent storage 511 (including operating system 512 and block 501, as identified above), peripheral device set 513 (including user interface (UI) device set 514, storage 515, and Internet of Things (IoT) sensor set 516), and network module 517. Remote server 503 includes remote database 518. Public cloud 504 includes gateway 519, cloud orchestration module 520, host physical machine set 521, virtual machine set 522, and container set 523.

Classical computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 518. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically classical computer 102, to keep the presentation as simple as possible. Classical computer 102 may be located in a cloud, even though it is not shown in a cloud in FIG. 5. On the other hand, classical computer 102 is not required to be in a cloud except to any extent as may be affirmatively indicated.

Processor set 506 includes one, or more, computer processors of any type now known or to be developed in the future. Processing circuitry 507 may be distributed over multiple packages, for example, multiple, coordinated integrated circuit chips. Processing circuitry 507 may implement multiple processor threads and/or multiple processor cores. Cache 508 is memory that is located in the processor chip package(s) and is typically used for data or code that should be available for rapid access by the threads or cores running on processor set 506. Cache memories are typically organized into multiple levels depending upon relative proximity to the processing circuitry. Alternatively, some, or all, of the cache for the processor set may be located “off chip.” In some computing environments, processor set 506 may be designed for working with qubits and performing quantum computing.

Computer readable program instructions are typically loaded onto classical computer 102 to cause a series of operational steps to be performed by processor set 506 of classical computer 102 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 508 and the other storage media discussed below. The program instructions, and associated data, are accessed by processor set 506 to control and direct performance of the inventive methods. In computing environment 500, at least some of the instructions for performing the inventive methods may be stored in block 501 in persistent storage 511.

Communication fabric 509 is the signal conduction paths that allow the various components of classical computer 102 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 510 is any type of volatile memory now known or to be developed in the future. Examples include dynamic type random access memory (RAM) or static type RAM. Typically, the volatile memory is characterized by random access, but this is not required unless affirmatively indicated. In classical computer 102, the volatile memory 510 is located in a single package and is internal to classical computer 102, but, alternatively or additionally, the volatile memory may be distributed over multiple packages and/or located externally with respect to classical computer 102.

Persistent Storage 511 is any form of non-volatile storage for computers that is now known or to be developed in the future. The non-volatility of this storage means that the stored data is maintained regardless of whether power is being supplied to classical computer 102 and/or directly to persistent storage 511. Persistent storage 511 may be a read only memory (ROM), but typically at least a portion of the persistent storage allows writing of data, deletion of data and re-writing of data. Some familiar forms of persistent storage include magnetic disks and solid state storage devices. Operating system 512 may take several forms, such as various known proprietary operating systems or open source Portable Operating System Interface type operating systems that employ a kernel. The code included in block 501 typically includes at least some of the computer code involved in performing the inventive methods.

Peripheral device set 513 includes the set of peripheral devices of classical computer 102. Data communication connections between the peripheral devices and the other components of classical computer 102 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 514 may include components such as a display screen, speaker, microphone, wearable devices (such as goggles and smart watches), keyboard, mouse, printer, touchpad, game controllers, and haptic devices. Storage 515 is external storage, such as an external hard drive, or insertable storage, such as an SD card. Storage 515 may be persistent and/or volatile. In some embodiments, storage 515 may take the form of a quantum computing storage device for storing data in the form of qubits. In embodiments where classical computer 102 is required to have a large amount of storage (for example, where classical computer 102 locally stores and manages a large database) then this storage may be provided by peripheral storage devices designed for storing very large amounts of data, such as a storage area network (SAN) that is shared by multiple, geographically distributed computers. IoT sensor set 516 is made up of sensors that can be used in Internet of Things applications. For example, one sensor may be a thermometer and another sensor may be a motion detector.

Network module 517 is the collection of computer software, hardware, and firmware that allows classical computer 102 to communicate with other computers through WAN 113. Network module 517 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 517 are performed on the same physical hardware device. In other embodiments (for example, embodiments that utilize software-defined networking (SDN)), the control functions and the forwarding functions of network module 517 are performed on physically separate devices, such that the control functions manage several different network hardware devices. Computer readable program instructions for performing the inventive methods can typically be downloaded to classical computer 102 from an external computer or external storage device through a network adapter card or network interface included in network module 517.

WAN 113 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 502 is any computer system that is used and controlled by an end user (for example, a customer of an enterprise that operates classical computer 102), and may take any of the forms discussed above in connection with classical computer 102. EUD 502 typically receives helpful and useful data from the operations of classical computer 102. For example, in a hypothetical case where classical computer 102 is designed to provide a recommendation to an end user, this recommendation would typically be communicated from network module 517 of classical computer 102 through WAN 113 to EUD 502. In this way, EUD 502 can display, or otherwise present, the recommendation to an end user. In some embodiments, EUD 502 may be a client device, such as thin client, heavy client, mainframe computer, desktop computer and so on.

Remote server 503 is any computer system that serves at least some data and/or functionality to classical computer 102. Remote server 503 may be controlled and used by the same entity that operates classical computer 102. Remote server 503 represents the machine(s) that collect and store helpful and useful data for use by other computers, such as classical computer 102. For example, in a hypothetical case where classical computer 102 is designed and programmed to provide a recommendation based on historical data, then this historical data may be provided to classical computer 102 from remote database 518 of remote server 503.

Public cloud 504 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 504 is performed by the computer hardware and/or software of cloud orchestration module 520. The computing resources provided by public cloud 504 are typically implemented by virtual computing environments that run on various computers making up the computers of host physical machine set 521, which is the universe of physical computers in and/or available to public cloud 504. The virtual computing environments (VCEs) typically take the form of virtual machines from virtual machine set 522 and/or containers from container set 523. It is understood that these VCEs may be stored as images and may be transferred among and between the various physical machine hosts, either as images or after instantiation of the VCE. Cloud orchestration module 520 manages the transfer and storage of images, deploys new instantiations of VCEs and manages active instantiations of VCE deployments. Gateway 519 is the collection of computer software, hardware, and firmware that allows public cloud 504 to communicate through WAN 113.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 505 is similar to public cloud 504, except that the computing resources are only available for use by a single enterprise. While private cloud 505 is depicted as being in communication with WAN 113 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 504 and private cloud 505 are both part of a larger hybrid cloud.

Block 501 further includes the software components discussed above in connection with FIGS. 2-4 to map a quantum circuit to a quantum processor by performing a light cone analysis. In one embodiment, such components may be implemented in hardware. The functions discussed above performed by such components are not generic computer functions. As a result, classical computer 102 is a particular machine that is the result of implementing specific, non-generic computer functions.

In one embodiment, the functionality of such software components of classical computer 102, including the functionality for mapping a quantum circuit to a quantum processor by performing a light cone analysis, may be embodied in an application specific integrated circuit.

As stated above, quantum applications have to be adapted to the hardware constraints imposed by current quantum processors. For example, one constraint is the elementary gate set. Generally, only a limited set of quantum gates that can be realized with relatively high fidelity will be predefined on a quantum device. Each quantum technology may support a specific universal set of single-qubit and two-qubit gates. For instance, some superconducting quantum technologies have CZ as an elementary two-qubit gate. Another constraint is the qubit connectivity. Quantum technologies, such as superconducting qubits and quantum dots, nominally arrange their qubits in 2D architectures with nearest-neighbor (NN) interactions. This means that only neighboring qubits can interact or in other words, qubits are required to be adjacent for performing a two-qubit gate. In other technologies such as trapped-ion qubits, they are fully connected and allow all-to-all interactions. A further constraint is classical control. Classical electronics are required for controlling and operating the qubits. Using a dedicated instrument per qubit is not scalable and a very expensive approach. Therefore, shared control is required especially when building scalable quantum processors. All these constraints may vary between different qubit implementations and even within the same quantum technology. In order to meet them, a mapping procedure (quantum circuit mapping) is required to transform a hardware-agnostic quantum circuit into a hardware-aware version that can be run on a given quantum processor. Such quantum circuit mapping involves mapping virtual qubits (qubits in the circuit) to hardware qubits (physical qubits in the processor). Furthermore, quantum circuit mapping involves routing qubits to move non-adjacent qubits to neighboring positions when they need to interact. To this purpose, the path that the qubits will follow needs to be determined and movement operations, such as shuttling in trapped ion and Si-spin quantum processors, will be inserted accordingly. It is noted that routing will increase the number of operations as well as the circuit depth (the count of time steps needed to execute all the gates in a quantum circuit). Furthermore, quantum circuit mapping involves scheduling the operations respecting not only the dependencies between them but also the classical control constraints. In addition, gates will be decomposed to elementary gates and the quantum circuit will be optimized at different stages of the compilation process. Superconducting systems are currently the leading technology for scalable, high-fidelity quantum processors. However, variability across superconducting processors in terms of important performance metrics, such as gate and measurement errors, and qubit coherence times gives rise to large deviations in circuit execution performance across the chip. At present, quantum circuit mapping techniques that heuristically place a quantum circuit on a set of qubits based on device error rates are frequently used. However, these methods do not take into consideration the observable (operator, where the property of the quantum state can be determined by some sequence of operations), if any, that is being evaluated from the output of the quantum circuit. For the common case of low-weight observables, only a subset of the operations in the quantum circuit affect the resulting observable value, especially for low-depth circuits that are executable today, indicating that quantum circuit mapping based on circuit information alone is not enough to ensure that the transformed quantum circuit is optimally mapped to a target device to maximize fidelity of the circuit output.

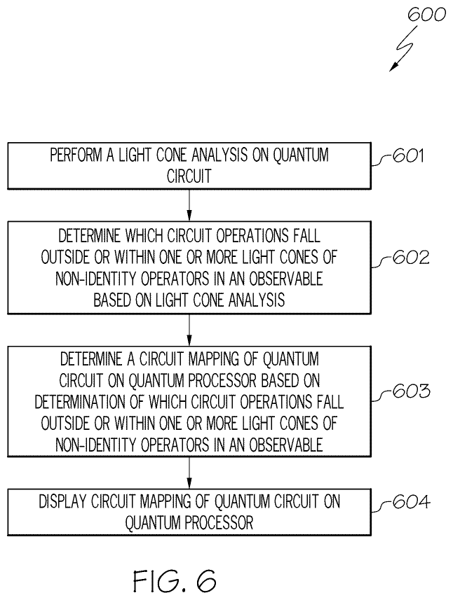

The embodiments of the present disclosure provide the means for mapping a quantum circuit to a quantum processor that takes into account the observables (operator, where the property of the quantum state can be determined by some sequence of operations) that are evaluated from the quantum circuit output by performing a light cone analysis thereby ensuring that the transformed quantum circuit is optimally mapped to a target device to maximize fidelity of the circuit output as discussed below in connection with FIG. 6.

FIG. 6 is a flowchart of a method 600 for mapping a quantum circuit to a quantum processor by performing a light cone analysis in accordance with an embodiment of the present disclosure.

Referring to FIG. 6, in conjunction with FIGS. 1-5, in step 601, analysis engine 201 of classical computer 102 performs a light cone analysis on a quantum circuit (e.g., quantum circuit 109).

As discussed above, a “light cone,” as used herein, refers to a map of the effects that the circuit operations have on the final observable value. A “light cone analysis,” as used herein, refers to the analysis of the quantum circuit generating one or more light cones. Based on the light cone analysis, the circuit operations which fall outside or within one or more light cones of non-identity operators in an observable are determined as discussed further below.

In one embodiment, analysis engine 201 generates the light cone by computing time-evolved commutators of circuit operations and an observable (e.g., energy) on a portion of the quantum circuit (e.g., quantum circuit 109). Commutators provide an indication of the extent to which a circuit operation impacts the observed outcome with respect to the observable (e.g., energy). An observable, as used herein, refers to the properties of the system that can be measured, such as position, momentum, angular momentum, energy, a binary value of a qubit, etc. As a result, the light cone indicates the impact of the circuit operation on the final observable value.

In one embodiment, analysis engine 201 generates the light cone by the quantum hyperbolae T 2−X 2=±[X, T]=±1. In one embodiment, the light cone corresponds to the surface describing the temporal evolution of a flash of light in Minkowski spacetime.

In one embodiment, such a light cone corresponds to a light cone of the non-identity operators in a given observable, where measurements of the number of light cones that intersect a given circuit operation may be displayed in a map as shown in FIG. 3.

In step 602, analysis engine 201 of classical computer 102 determines which circuit operations fall outside or within one or more light cones of non-identity operators in an observable based on the light cone analysis on the quantum circuit.

As stated above, those circuit operations that fall outside the light cones of non-identity operators in an observable have no role in the final observable value and therefore can be ignored in the quantum circuit mapping process. Those circuit operations that fall within the light cone(s) of non-identity operators in an observable do have an impact in the final observable value and are utilized in the quantum circuit mapping process as discussed further below.

In one embodiment, based on the light cone analysis on the quantum circuit, measurements of the number of light cones that intersect a given circuit operation may be displayed in a map as shown in FIG. 3.

Referring to FIG. 3, the light cone analysis performed on the quantum circuit generates a map 300 containing a numerical value 301 (e.g., 0, 1) for each circuit operation which indicates a number of light cones that intersect the circuit operation. Such numerical values 301 are computed by measurement operation 302 based on the analysis performed by analysis engine 201 in determining which circuit operations fall outside or within a light cone of non-identity operators in an observable. For example, such numerical values 301 may indicate a value of 0 to indicate that the corresponding circuit operation falls outside the light cones of non-identity operators in an observable; whereas, a value of 1 indicates that the corresponding circuit operation falls within a light cone of non-identity operators in an observable.

In one embodiment, analysis engine 201 identifies those circuit operations that fall outside the light cones of non-identity operators in an observable based on being associated with a numerical value of 0 in map 300. Such circuit operations have no role in the final observable value and therefore can be ignored in the quantum circuit mapping process. In one embodiment, analysis engine 201 optionally removes such circuit operations from the quantum circuit, such as to reduce the possibility of cross-talk.

As previously discussed, such circuit operations that fall within a light cone of non-identity operators in an observable are identified based on being associated with a numerical value of 1 in map 300. In one embodiment, analysis engine 201 prioritizes such circuit operations based on the number of overlapping or individual light cones that such circuit operations lie within as discussed below in connection with FIG. 4.

As shown in FIG. 4, based on the light cone analysis performed on the quantum circuit, measurements of the number of light cones that intersect a given circuit operation may be displayed in map 400, where map 400 indicates the number of overlapping or individual light cones that such circuit operations lie within via numerical values 301. In one embodiment, such numerical values 301 are computed by measurement operation 302 based on the analysis performed by analysis engine 201 in determining which circuit operations fall outside or within one or more light cones of non-identity operators in an observable.

For example, as shown in FIG. 4, such numerical values 301 may indicate a value of 0 to indicate that the corresponding circuit operation falls outside the light cones of non-identity operators in an observable, a value of 1 to indicate that the corresponding circuit operation falls within a light cone of non-identity operators in an observable, or a value of 2 to indicate that the corresponding circuit operation falls within two light cones of non-identity operators in an observable. The higher the value of numerical value 301, the greater the impact that the corresponding circuit operation has on the final observable value. While map 400 only illustrates the values of 0, 1 and 2 for numerical values 301, the circuit operations may fall within any number of light cones of non-identity operators in an observable, and hence, numerical values 301 may indicate other values than 0, 1 and 2, such as 3, 4, etc.

For observables of weight lager than one (i.e., circuit operations being associated with a numerical value 301 greater than one), the intersection of light cones indicates that operators within the intersection impact multiple terms in the observable, and thus have an outsized impact on the resulting output. As a result, mapping (quantum circuit mapping) such circuit operations to the gates and qubits with lower error rates are prioritized over circuit operations that lie within a smaller number of overlapping or individual light cones.

In step 603, mapping engine 202 of classical computer 102 determines a circuit mapping of the quantum circuit (e.g., quantum circuit 109) on the quantum processor (e.g., quantum processor 108) based on the determination of which circuit operations fall outside or within the one or more light cones of non-identity operators in the observable.

As discussed above, in one embodiment, mapping engine 202 performs the circuit mapping of the quantum circuit (e.g., quantum circuit 109) on the quantum processor (e.g., quantum processor 108) based on the prioritization (or weighting) of the circuit operations, which is based on the determination of which circuit operations fall outside or within the one or more light cones of non-identity operators in the observable. In one embodiment, mapping engine 202 maps the circuit operations to the gates and qubits based, at least in part, on the impact on the final observable value identified from the light cone analysis. As discussed above, those circuit operations that are within the light cones as identified from the light cone analysis are prioritized based on the number of overlapping or individual light cones that such circuit operations lie within. In one embodiment, based on such prioritization (or weightings), along with gate and qubit errors, circuit operations are mapped to the gates and qubits.

In one embodiment, mapping engine 202 performs the circuit mapping of the quantum circuit (e.g., quantum circuit 109) on the quantum processor (e.g., quantum processor 108) using a heuristic scoring of the quantum circuit in terms of such prioritizations (or weights). In one embodiment, mapping engine 202 performs the circuit mapping of the quantum circuit (e.g., quantum circuit 109) on the quantum processor (e.g., quantum processor 108) using a heuristic scoring of the quantum circuit in terms of such prioritizations (or weights) in combination with the gate and qubit errors.

In one embodiment, mapping engine 202 performs the circuit mapping of the quantum circuit (e.g., quantum circuit 109) on the quantum processor (e.g., quantum processor 108) based on the prioritization (or weighting) of the circuit operations using various software tools, including, but not limited to, Mapomatic, Munich Quantum Toolkit (MQT) QMAP, etc.

In step 604, mapping engine 202 of classical system 102 displays the circuit mapping of the quantum circuit (e.g., quantum circuit 109) on the quantum processor (e.g., quantum processor 108), where the circuit operations are mapped to the gates and qubits based on the determination of which circuit operations fall outside or within the one or more light cones of non-identity operators in the observable.

As stated above, in one embodiment, mapping engine 202 is configured to display the circuit mapping of the quantum circuit (e.g., quantum circuit 109) on the quantum processor (e.g., quantum processor 108), where the circuit operations are mapped to the gates and qubits based, at least in part, on the prioritization (or weighting) of the circuit operations identified from the light cone analysis. In one embodiment, such a circuit mapping of the quantum circuit on the quantum processor is displayed on a user interface of a computing device (e.g., classical computer 102). In one embodiment, mapping engine 202 utilizes various software tools for displaying the circuit mapping of the quantum circuit on the quantum processor, including, but not limited to, Berkeley Quantum Synthesis Toolkit, Mapomatic, Munich Quantum Toolkit (MQT) QMAP, etc.

In this manner, by weighting the circuit operations by the number of light cones they lie within, where such light cones map the effects that the circuit operations have on the final observable value, the quantum circuit mapping process now more accurately ensures that the transformed quantum circuit complies with the quantum computer architecture's limited qubit connectivity and optimized for output fidelity.

Furthermore, the principles of the present disclosure improve the technology or technical field involving quantum circuit mapping.

As discussed above, quantum applications have to be adapted to the hardware constraints imposed by current quantum processors. For example, one constraint is the elementary gate set. Generally, only a limited set of quantum gates that can be realized with relatively high fidelity will be predefined on a quantum device. Each quantum technology may support a specific universal set of single-qubit and two-qubit gates. For instance, some superconducting quantum technologies have CZ as an elementary two-qubit gate. Another constraint is the qubit connectivity. Quantum technologies, such as superconducting qubits and quantum dots, nominally arrange their qubits in 2D architectures with nearest-neighbor (NN) interactions. This means that only neighboring qubits can interact or in other words, qubits are required to be adjacent for performing a two-qubit gate. In other technologies such as trapped-ion qubits, they are fully connected and allow all-to-all interactions. A further constraint is classical control. Classical electronics are required for controlling and operating the qubits. Using a dedicated instrument per qubit is not scalable and a very expensive approach. Therefore, shared control is required especially when building scalable quantum processors. All these constraints may vary between different qubit implementations and even within the same quantum technology. In order to meet them, a mapping procedure (quantum circuit mapping) is required to transform a hardware-agnostic quantum circuit into a hardware-aware version that can be run on a given quantum processor. Such quantum circuit mapping involves mapping virtual qubits (qubits in the circuit) to hardware qubits (physical qubits in the processor). Furthermore, quantum circuit mapping involves routing qubits to move non-adjacent qubits to neighboring positions when they need to interact. To this purpose, the path that the qubits will follow needs to be determined and movement operations, such as shuttling in trapped ion and Si-spin quantum processors, will be inserted accordingly. It is noted that routing will increase the number of operations as well as the circuit depth (the count of time steps needed to execute all the gates in a quantum circuit). Furthermore, quantum circuit mapping involves scheduling the operations respecting not only the dependencies between them but also the classical control constraints. In addition, gates will be decomposed to elementary gates and the quantum circuit will be optimized at different stages of the compilation process. Superconducting systems are currently the leading technology for scalable, high-fidelity quantum processors. However, variability across superconducting processors in terms of important performance metrics, such as gate and measurement errors, and qubit coherence times gives rise to large deviations in circuit execution performance across the chip. At present, quantum circuit mapping techniques that heuristically place a quantum circuit on a set of qubits based on device error rates are frequently used. However, these methods do not take into consideration the observable (operator, where the property of the quantum state can be determined by some sequence of operations), if any, that is being evaluated from the output of the quantum circuit. For the common case of low-weight observables, only a subset of the operations in the quantum circuit affect the resulting observable value, especially for low-depth circuits that are executable today, indicating that quantum circuit mapping based on circuit information alone is not enough to ensure that the transformed quantum circuit is optimally mapped to a target device to maximize fidelity of the circuit output.

Embodiments of the present disclosure improve such technology by performing a light cone analysis on the quantum circuit. A “light cone,” as used herein, refers to a map of the effects that the circuit operations have on the final observable value. A “light cone analysis,” as used herein, refers to the analysis of the quantum circuit generating one or more light cones. In one embodiment, the light cone is generated by computing time-evolved commutators of circuit operations and an observable (e.g., energy) on a portion of the quantum circuit. Commutators provide an indication of the extent to which a circuit operation impacts the observed outcome with respect to the observable (e.g., energy). An observable, as used herein, refers to the properties of the system that can be measured, such as position, momentum, angular momentum, energy, a binary value of a qubit, etc. As a result, the light cone indicates the impact of the circuit operation on the final observable. Circuit operations that fall outside or within the one or more light cones of non-identity operators in an observable based on the light cone analysis on the quantum circuit are then determined. Those circuit operations that fall outside the light cones of non-identity operators in an observable have no role in the final observable value and therefore can be ignored in the quantum circuit mapping process. Those circuit operations that fall within the light cone(s) of non-identity operators in an observable do have an impact in the final observable value and are utilized in the quantum circuit mapping process. The greater the number of overlapping or individual light cones that such circuit operations lie within, the greater the impact that such circuit operations have on the final observable value. A circuit mapping of the quantum circuit on the quantum processor is then determined based on the determination of which circuit operations fall outside or within the one or more light cones of non-identity operators in the observable. In one embodiment, the circuit operations are mapped to the gates and qubits based, at least in part, on the impact on the final observable value identified from the light cone analysis. Those circuit operations that are within the light cones as identified from the light cone analysis are prioritized based on the number of overlapping or individual light cones that such circuit operations lie within, where the greater number of overlapping or individual light cones, the higher the priority. Based on such prioritization (or weightings), along with gate and qubit errors, circuit operations are mapped to the gates and qubits. In this manner, the quantum circuit mapping process now more accurately ensures that the transformed quantum circuit complies with the quantum computer architecture's limited qubit connectivity. Furthermore, in this manner, there is an improvement in the technical field involving quantum circuit mapping.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for mapping a quantum circuit to a quantum processor, the method comprising:
performing a light cone analysis on said quantum circuit;
determining which circuit operations fall outside or within one or more light cones of non-identity operators in an observable based on said light cone analysis on said quantum circuit; and
determining a circuit mapping of said quantum circuit on said quantum processor based on said determination of which circuit operations fall outside or within said one or more light cones of non-identity operators in said observable.

2. The method as recited in claim 1 further comprising:
displaying said circuit mapping of said quantum circuit on said quantum processor, wherein said circuit operations are mapped to gates and qubits based on said determination of which circuit operations fall outside or within said one or more light cones of non-identity operators in said observable.

3. The method as recited in claim 1, wherein said light cone analysis performed on said quantum circuit generates a numerical value for each circuit operation which indicates a number of light cones that intersect said circuit operation.

4. The method as recited in claim 3, wherein a higher value of said numerical value associated with said circuit operation indicates a greater impact on a final observable value.

5. The method as recited in claim 4, wherein said circuit operations are prioritized for being mapped to gates and qubits based on said numerical value.

6. The method as recited in claim 3, wherein circuit operations that are associated with a numerical value of zero correspond to circuit operations that fall outside of said one or more light cones.

7. The method as recited in claim 6 further comprising:
removing said circuit operations that are associated with said numerical value of zero from said quantum circuit.

8. A computer program product for mapping a quantum circuit to a quantum processor, the computer program product comprising one or more computer readable storage mediums having program code embodied therewith, the program code comprising programming instructions for:
performing a light cone analysis on said quantum circuit;
determining which circuit operations fall outside or within one or more light cones of non-identity operators in an observable based on said light cone analysis on said quantum circuit; and
determining a circuit mapping of said quantum circuit on said quantum processor based on said determination of which circuit operations fall outside or within said one or more light cones of non-identity operators in said observable.

9. The computer program product as recited in claim 8, wherein the program code further comprises the programming instructions for:
displaying said circuit mapping of said quantum circuit on said quantum processor, wherein said circuit operations are mapped to gates and qubits based on said determination of which circuit operations fall outside or within said one or more light cones of non-identity operators in said observable.

10. The computer program product as recited in claim 8, wherein said light cone analysis performed on said quantum circuit generates a numerical value for each circuit operation which indicates a number of light cones that intersect said circuit operation.

11. The computer program product as recited in claim 10, wherein a higher value of said numerical value associated with said circuit operation indicates a greater impact on a final observable value.

12. The computer program product as recited in claim 11, wherein said circuit operations are prioritized for being mapped to gates and qubits based on said numerical value.

13. The computer program product as recited in claim 10, wherein circuit operations that are associated with a numerical value of zero correspond to circuit operations that fall outside of said one or more light cones.

14. The computer program product as recited in claim 13, wherein the program code further comprises the programming instructions for:
removing said circuit operations that are associated with said numerical value of zero from said quantum circuit.

15. A system, comprising:
a memory for storing a computer program for mapping a quantum circuit to a quantum processor; and
a processor connected to said memory, wherein said processor is configured to execute program instructions of the computer program comprising:
performing a light cone analysis on said quantum circuit;
determining which circuit operations fall outside or within one or more light cones of non-identity operators in an observable based on said light cone analysis on said quantum circuit; and
determining a circuit mapping of said quantum circuit on said quantum processor based on said determination of which circuit operations fall outside or within said one or more light cones of non-identity operators in said observable.

16. The system as recited in claim 15, wherein the program instructions of the computer program further comprise:
displaying said circuit mapping of said quantum circuit on said quantum processor, wherein said circuit operations are mapped to gates and qubits based on said determination of which circuit operations fall outside or within said one or more light cones of non-identity operators in said observable.

17. The system as recited in claim 15, wherein said light cone analysis performed on said quantum circuit generates a numerical value for each circuit operation which indicates a number of light cones that intersect said circuit operation.

18. The system as recited in claim 17, wherein a higher value of said numerical value associated with said circuit operation indicates a greater impact on a final observable value.

19. The system as recited in claim 18, wherein said circuit operations are prioritized for being mapped to gates and qubits based on said numerical value.

20. The system as recited in claim 17, wherein circuit operations that are associated with a numerical value of zero correspond to circuit operations that fall outside of said one or more light cones.
